(19) United States
(12) Patent Application Publication
(10) Pub. No.: US 2006/0014124 A1
(43) Pub. Date: Jan. 19, 2006

(54) System and method for controlling/normalizing compulsive behaviors such as eating disorders

(76) Inventor: Lucian Manu, New York, NY (US)

Correspondence Address: SOFER & HAROUN, L.L.P.;Suite 910, 317 Madison Avenue, New York, NY, 10017, US

(21) Appl. No.: 10/895,248

(22) Filed: Jul. 19, 2004

(51) Int. Cl. G09B 19/00

(52) U.S. Cl. 434/236

(57) ABSTRACT

A system is provided for assisting a user in compulsive eating behavior normalization and weight-loss. The system includes an interface module configured to allow the user interface with the system. A hunger evaluation module, coupled to the interface module, evaluates the user's desire to eat to determine if it is caused by emotional stimuli, physical stimuli or both. An emotional hunger management module, coupled to the interface module interacts with the user to assist in alleviating emotional stimuli to eat. A physical hunger management module, coupled to the interface module, assists the user when the decision to eat has been made.

### FIELD OF THE INVENTION

The present invention is related to a system and method for identifying a compulsive behavior about to happen and achieving control over such compulsive behavior, such as compulsive eating. More specifically, the present invention is related to a system and method of questions and answers, and instructions that assist in identifying such compulsive behavior and achieving such control over it, so as, for example, to lose weight.

### BACKGROUND OF THE INVENTION

With the prevalence of weight problems and obesity, a significant amount of time, energy and money is expended on various weight loss programs, attempting to formulate diets and other measures which are intended to cause a reduction in weight. For the most part, these diets focus on the level of fats, carbohydrates, protein, or other physical characteristics of the foods to be consumed.

Among these programs, however, there is a lack of weight loss or diet methodologies that take into account both the emotional-behavioral and physical causes of weight gain. Furthermore, many weight loss programs fail to provide a comprehensive evaluation of the nature of hunger that prompts one's eating behavior, to determine whether that hunger is in fact either a physical hunger, an emotionally caused hunger, or a combination of both. Failure to recognize an emotional cause for eating reduces the effectiveness of most weight loss plans because losing weight and keeping it off are hardly doable without normalizing one's compulsive eating behavior.

Significantly more effective than dieting alone is the use of personal trainers, who deal not only with physical eating problems, such as food choices and exercise, but also assist in formulating the correct mental, emotional and eating behavioral state required for effective weight loss. However, personal trainers are expensive and time consuming, and are thus not widely available to the public.

### OBJECT AND SUMMARY OF THE INVENTION

The present invention looks to overcome the drawbacks associated with the prior art and provide a low cost system and method for determining the cause of a user's hunger, based on responses given to a series of questions. Using the answers provided, the present invention is able to determine whether the hunger experienced by a user in real time is caused by emotional stimuli, physical stimuli or a combination of both.

Using a series of questions and the responses given by the user, the system is able to determine in real time the cause of the hunger and assist by providing information that will help the user normalize compulsive eating behavior and lose weight. Typically, the questions and responses will be done utilizing a computer program, however the invention is not limited in this respect. Additionally, by providing such system, the user can make use of the diagnostic tools of the system in real time, at any time, rather than being confined to limited time frames where a personal trainer may be present.

To this end, the present invention provides for a system for assisting a user in normalizing compulsive (eating) behavior and weight-loss having an interface module configured to allow the user interface with the system.

A hunger evaluation module, coupled to the interface module, is configured to evaluate the user's desire to eat, to determine whether it is caused by emotional stimuli, physical stimuli, or both.

An emotional hunger management module, coupled to the interface module, is configured to interact with the user to assist in alleviating emotional stimuli to eat.

A physical hunger module, coupled to the interface module, is configured to assist the user when the decision to eat has been made.

A database of food choices classified according to food attributes such as appearance, smell, taste, texture, temperature, and how healthy they are, help the user make better and more satisfying food choices.

Over time, the system will track and record in a storage module all the interactions with the user. The data stored in the storage module will be used by a reporting module to provide feed back to the user and/or his/her clinician(s).

Although various embodiments discussed here relate to normalizing compulsive eating behavior and weight loss issues, it can be appreciated by those skilled in the art that other types of compulsive behaviors such as, but not limited to: compulsive smoking, compulsive alcohol drinking, drug abuse, compulsive gambling, compulsive sexual activities, etc may be significantly curtailed and normalized by applying the principles in accordance with the present invention.

### BRIEF DESCRIPTION OF THE DRAWINGS

The present invention is illustrated by way of example and not by way of limitation in the figures of the accompanying drawings, in which like references indicate similar elements and in which:

FIG. 1 illustrates a compulsive eating behavior normalization and weight loss system in accordance with one embodiment of the present invention;

FIG. 2 is flow chart of the operation of a hunger evaluation module of the compulsive eating behavior normalization and weight loss system of FIG. 1, in accordance with one embodiment of the present invention;

FIG. 3 is an interactive screen display of the hunger evaluation module, in accordance with one embodiment of the present invention;

FIG. 4 is an interactive screen display of the hunger evaluation module, in accordance with one embodiment of the present invention;

FIG. 5 is a table used by the hunger evaluation module of the compulsive eating behavior normalization and weight loss system of FIG. 1, in accordance with one embodiment of the present invention;

FIG. 6 is an interactive screen display of the hunger evaluation module, in accordance with one embodiment of the present invention;

FIG. 7 is an interactive screen display of the hunger evaluation module, in accordance with one embodiment of the present invention;

FIG. 8 is an interactive screen display of the hunger evaluation module, in accordance with one embodiment of the present invention;

FIG. 9 is a flow chart of the operation of an emotional hunger management module of the compulsive eating behavior normalization and weight loss system of FIG. 1, in accordance with one embodiment of the present invention;

FIG. 10 is an interactive screen display of the emotional hunger management module, in accordance with one embodiment of the present invention;

FIG. 11 is an interactive screen display of the emotional hunger management module, in accordance with one embodiment of the present invention;

FIG. 12 is an interactive screen display of the emotional hunger management module, in accordance with one embodiment of the present invention;

FIG. 13 is an interactive screen display of the emotional hunger management module, in accordance with one embodiment of the present invention;

FIG. 14 is flow chart of the operation of a physical hunger management module of the compulsive eating behavior normalization and weight loss system of FIG. 1, in accordance with one embodiment of the present invention;

FIG. 15 is an interactive screen display of the physical hunger management module, in accordance with one embodiment of the present invention; and

FIG. 16 is an interactive screen display of the physical hunger management module, in accordance with one embodiment of the present invention.

### DETAILED DESCRIPTION

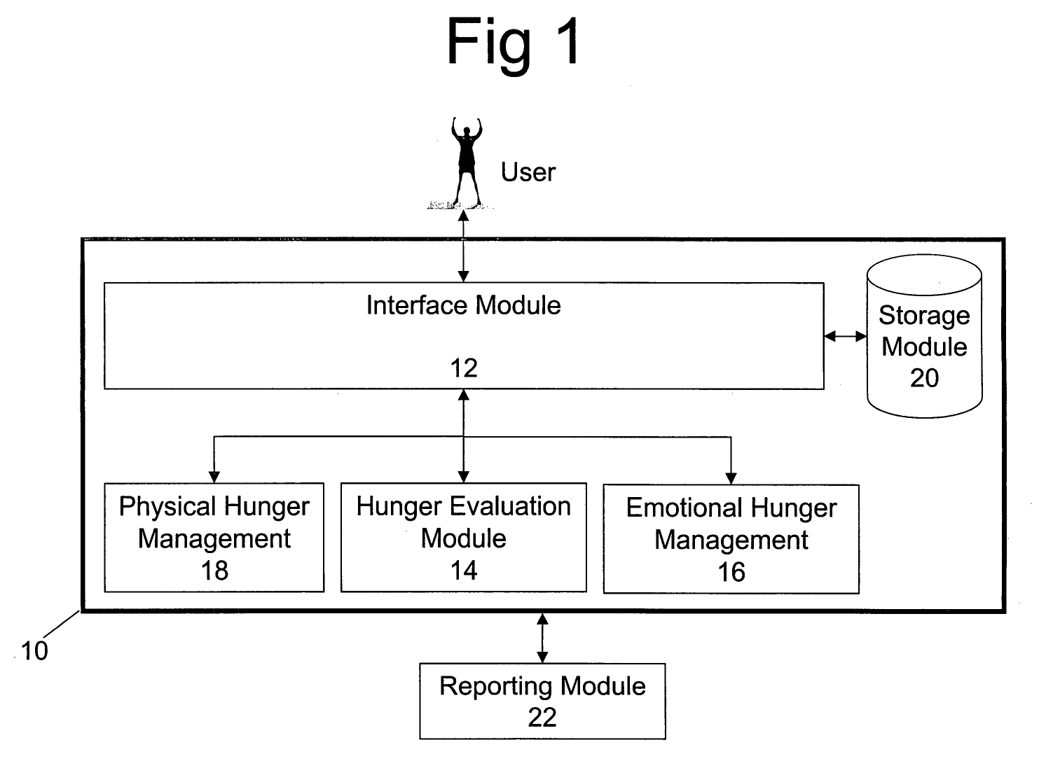

The present invention, as illustrated in FIG. 1, provides a compulsive eating behavior normalization and weight loss system 10, configured to conduct interactive communications with a user, so as to supply necessary eating behavioral and emotional support information to the user for the purposes of compulsive eating behavior normalization and weight loss, although the invention is not limited in scope in that respect. For example, other types of compulsive behavior such as drug addiction, compulsive gambling or any other compulsive problem-behavior. However for the purposes of illustration, the salient features of the system and method employed will be discussed in the context of treating a user for compulsive eating behavior normalization and weight loss.

When a user experiences a desire to eat, they consult the compulsive eating behavior normalization and weight loss system 10 to determine their next course of action. To this end, the compulsive eating behavior normalization and weight loss system 10, maintains a user interface module 12, configured to manage the communications between the user and system 10.

Interface module 12 of system 10, not only supports the display of questions to the user, but also maintains a means for managing the answers provided. As such, interface module 12 has a platform for presenting the user with questions, including but not limited to yes or no questions, multiple choice questions, multiple answer questions and answer range questions (eg. Between 1-10). The specific types of questions asked are explained in more detail below in the operation section.

It is noted that interface module 12 may be either a hardware module or it may be implemented as a software module, depending on the arrangement of the compulsive eating behavior normalization and weight loss system 10.

As illustrated in FIG. 1, compulsive eating behavior normalization and weight loss system 10 further maintains a hunger evaluation module 14, configured to receive the results/answers from interface module 12, and evaluate the origin of the user's hunger. Based on the answers to the questions supplied by interface module 12, hunger evaluation module 14 determines whether the hunger experienced is a result of physical hunger, emotional needs, or a combination of the two. The manner in which these decisions are made is discussed in more detail below. As with interface module 12, hunger evaluation module 14 may be either a hardware module or it may be implemented as a software module, depending on the arrangement of the compulsive eating behavior normalization and weight loss system 10.

The compulsive eating behavior normalization and weight loss system 10 further maintains an emotional hunger management module 16, configured to work in conjunction with interface module 12 to provide information to a user to manage their emotional need for food. In operation, assuming hunger evaluation module 14 has determined that the hunger is at least in part emotionally driven, questions and instructions are presented by emotional hunger management module 16 to the user, that assist in controlling and abating the emotionally driven hunger. Options are then presented to the user to assist in overcoming their emotionally driven hunger.

The full scope of the evaluation and mitigation of a user's emotionally driven hunger is explained in more detail below with respect to the specific interactive screens that are presented to the user. As with the other modules in the compulsive eating behavior normalization and weight loss system 10, emotional hunger management module 16 may be either a hardware module or it may be implemented as a software module, depending on the arrangement of the compulsive eating behavior normalization and weight loss system 10.

As illustrated in FIG. 1, the compulsive eating behavior normalization and weight loss system 10 further maintains a physical hunger management module 18, configured to work in conjunction with interface module 12 to provide information to a user to manage their physical hunger and corresponding intake of foods. In operation, assuming hunger evaluation module 14 has determined that the hunger is at least in part physically driven or assuming that the user has decided to eat, regardless of an emotionally driven hunger, questions and instructions are presented by physical hunger management module 18 to the user, that assists in preparing a proper healthy and balanced meal to address the user's hunger.

The full scope of the evaluation and preparation of a meal or snack to satisfy the hunger experienced by the user is explained in more detail below with respect to the specific interactive screens that are presented to the user. As with the other modules in the compulsive eating behavior normalization and weight loss system 10, physical hunger management module 18 may be either a hardware module or it may be implemented as a software module, depending on the arrangement of compulsive eating behavior normalization and weight loss system 10.

It is noted that physical hunger management module 18 may be integrated with specific diet plans, such that the evaluation and preparation of meals and snacks, as discussed in more detail below, is carried out in accordance with the requirements of those plans. For example, if a particular user is placed on a low-carbohydrate diet, physical hunger management module 18 supplies the user with low-carbohydrate options for meals and snacks. In another example, if the user is placed on a low-sodium diet, physical hunger management module 18, supplies the user with low sodium food options or even low sodium food preparation methods. In fact, physical hunger management module, is also configured to integrate its food choice and preparation options with preexisting commercial diets, already on the market such as Atkins™, Zone™ or Weight Watchers™, so that the user may benefit from the familiarity of the diets and their prepackaged meals and snacks.

As illustrated in FIG. 1, compulsive eating behavior normalization and weight loss system 10 further maintains a storage module 20, coupled to compulsive eating behavior normalization and weight loss system 10, configured to work in conjunction with all of the other modules to provide data storage capacity. For example, storage module 20 can maintain databases for storing food combinations having different textures, smells, and tastes for use by physical hunger management module in assisting the user in making more intelligent and healthy eating decisions.

In another example, storage module 20 can maintain records of a user's interactions with interaction module 12 for use or review at a later date. Likewise, storage module 20 may also store the calculations made by hunger evaluation module 14, emotional hunger management module 16 and physical hunger management module 18 so that they can be reviewed at a later date or possibly store saved preferences and the like.

Such features of storage module 20 can be used for many purposes. For Example, storage module 20, may be used by a user to stop in the middle of a session and take up again where they left off, or even review the results of previous sessions at a later time. Another use for storage module 20, would be to store user preferences (speed of interactive screens, other set up related issues) so that the same settings are used each time the users access system 10. Yet another example for using the features of storage module 20, would be to store multiple user settings and preferences, so that multiple users may use the same system 10 at different times.

It is also contemplated that a doctor using system 10, for a number of users, could make use of the stored statistics to compile overall data for a group of users to evaluate their progress. Such a system could actually employ a single centrally located storage module 20 or it could be accomplished by using a local storage module 20 at each of the user's locations, all of which communicate their stored results to a central storage module 20 located at the doctor's office.

Storage module 20, is principally used to store the above discussed information, however, additional functions for storage module 20 can also be used, such as storing the interactive screens, discussed below, used by the other compulsive eating behavior normalization and weight loss system modules, rather than those modules storing their own interactive screens. It is understood that above uses for storage module 20 are intended only as sample uses to illustrate the salient features of storage module 20. Any other features used on a similar storage module in conjunction with a similar compulsive eating behavior normalization and weight loss system, are also within the contemplation of the present invention.

As illustrated in FIG. 1, a reporting module 22, is coupled to compulsive eating behavior normalization and weight loss system 10, in order to facilitate reporting communications between the doctor and patient and possibly between remote devices used by the system.

For example, reporting module 22, may be coupled to a computer, located at the user's doctor's office whereby as a user' utilizes system 10, the data compiled in storage module 20 is also sent to the doctor's computer so that they may track results. Another example of the operation of reporting module 22 may include the ability to receive wireless reports from a handheld or mobile device such as a PDA, Blackberry or cellular device. In this arrangement, the system 10 may allow the user to operate some or all of the programming, as described below, remotely, the results of which are wirelessly communicated to reporting module 22 where they then can be communicated to storage module 20. As with the other modules of compulsive eating behavior normalization and weight loss system 10, reporting module 22 can be configured as an independent module or as a sub-component of another module, such as interface module 12.

It is understood that the above description of compulsive eating behavior normalization and weight loss system 10 and its modules, is intended as only one example of the arrangement for the system, and is in no way intended to limit the scope of the present invention. For example, the internal modules of compulsive eating behavior normalization and weight loss system 10, may be combined into a smaller number of multi-function modules, further sub-divided into additional modules or even merged into a single functional unit.

It is understood that compulsive eating behavior normalization and weight loss system 10, may also be implemented on any number of other forms of smaller electronic devices such as PDA (personal digital assistants), cellular phones, SMS (short message service) devices, text pagers, audio/video cd's or CD ROM's, or even on-line, via the internet.

Likewise, for the purposes of illustration, compulsive eating behavior normalization and weight loss system 10 is described as a computer program which presents a series of interactive screens, containing questions and answers to a user. However, a system using non-electronic media, such as flashcards, sliding rulers or wheel, or other similar devices, employing similar functional modules to effect compulsive eating behavior normalization and weight loss in a similar manner is within the contemplation of the present invention.

Turning to the operation of compulsive eating behavior normalization and weight loss system 10, each time a user feels the compulsion to eat, they are to access system 10, via interface module 12, and begin a compulsive eating behavior normalization and weight loss session. This process of performing a compulsive eating behavior normalization and weight loss session is repeated every time that a user experiences hunger and desires to eat.

At the beginning of a session the user is taken through programs, having a series of interactive screens that evaluate the cause of his/her hunger. Once the cause of the hunger has been evaluated by hunger evaluation module 14, emotional hunger and physical hunger modules 16 and 18 then address/treat the respective hunger by presenting the user with questions and instructions via a series of interactive screen.

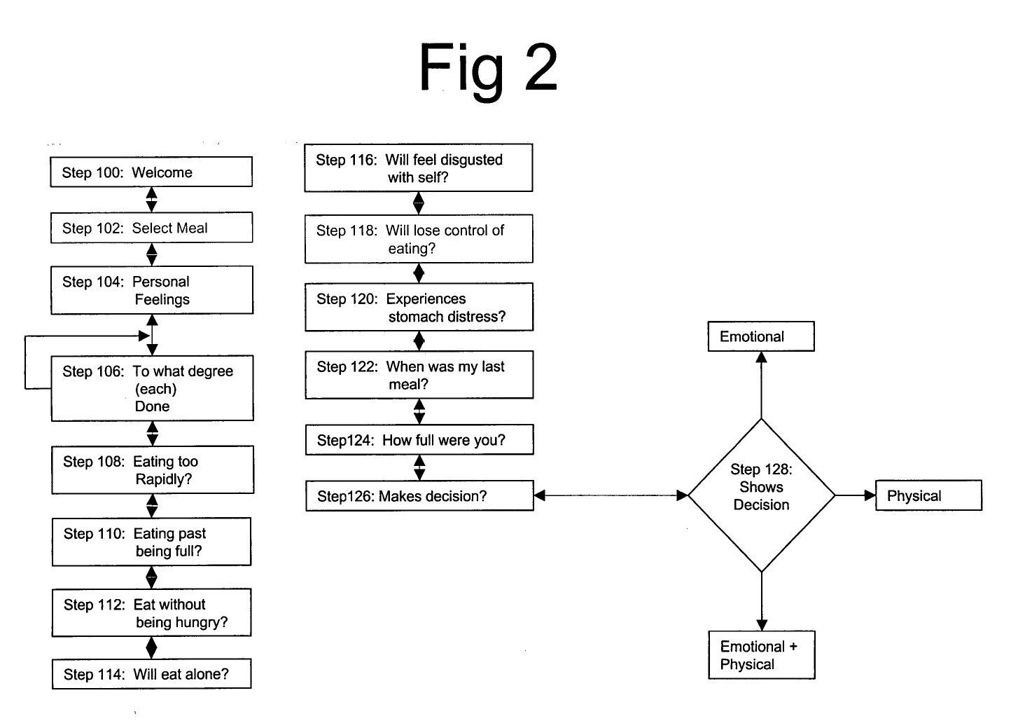

In one embodiment of the present invention, as illustrated in the flow chart FIG. 2, a user is provided with a series of interactive screens by hunger evaluation module 14. The interactive screens present a series of questions to the user that attempt to discern whether the currently experienced hunger is caused by an emotional need, a physical need (physiological hunger) or a combination of both.

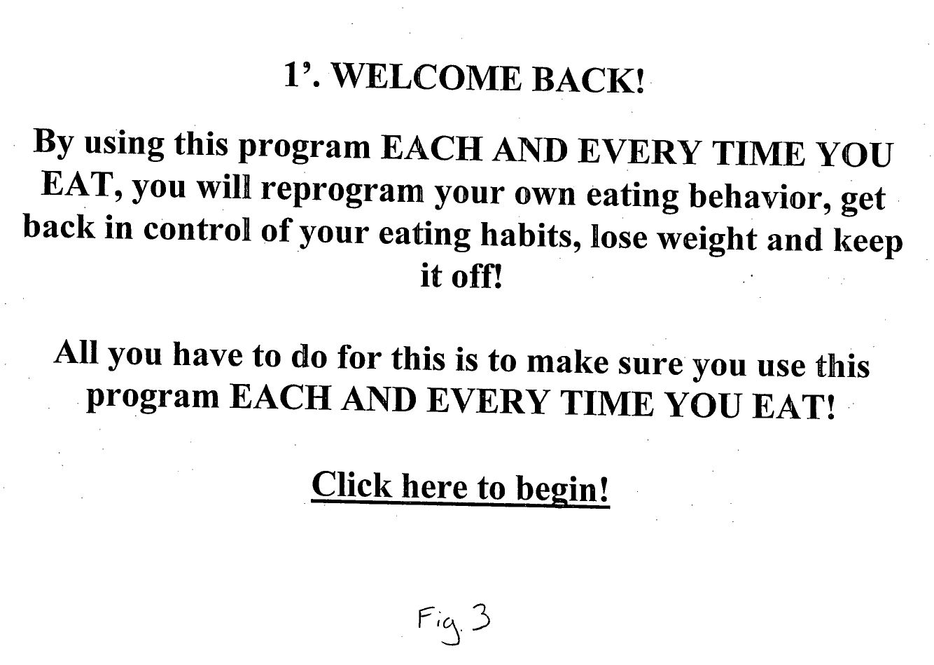

In operation, at step 100, system 10 issues a welcome screen to the user. Next, at step 102, system 10 requests that the user select a particular meal such as breakfast, lunch, dinner or snack. A sample interactive screen shown to the user of step 102 is shown in FIG. 3.

At step 104, the user is asked to select which personal feelings they are currently experiencing. The range of feelings includes the gamut of personal feelings including, but not limited to, loneliness, depression, fatigue, and so on. The user is prompted to select as many emotions as appropriate. It is understood that the full range of emotions or personal feelings presented at this stage is subject to change as more knowledge in the field of compulsive eating behavior normalization and weight loss uncovers more emotions that can have an effect on food cravings. Any similar step of indicating an emotional state in connection with a similar compulsive eating behavior normalization and weight loss system and method is within the contemplation of the present invention.

At step 106, hunger evaluation module 14 presents the user with an interactive screen asking the user to rate the strength of each personal feeling selected in step 104. The user is allowed to select across a broad range of levels between “not at all,” all the way to “extremely strong” This process is repeated until the user indicates the strength of each feeling that was indicated in the step 104.

It is noted that system 10 allows for the answers given in step 106 to be set across a broad range. In doing so, the ranges can be broken up into any subdivision scale that is adequate for differentiating between the different levels of feelings. For example, using a sliding scale, if the question asks, “How lonely are you feeling?” the response bar will allow the user to slide the indicator from “not at all” on the left to “extremely” on the right. In doing so system 10 may employ any style range of responses across the range bar such as awarding 0 points for an answer of “not at all” and 100 points for an answer of “extremely” The point increments may be subdivided into counting by 1's, 5's, or even 10's. It is understood that any such range of responses used on the range bar that is sufficient for the purposes of assisting in evaluating the cause of the hunger by hunger evaluation module 14, is within the contemplation of the present invention.

In accordance with one embodiment of the invention, if the user has used the program for many times and suspects that their hunger is more than likely emotional, the system may inquire the user if they actually suspect an emotional hunger, the system may take a short cut to the emotional pathway.

The questions and user's answers in response to the above questions are valuable to the user to help them understand the emotions that may be causing them to eat.

Irrespective of the answers given by the user to questions in steps 108 through 118, based on the mere selection of certain emotions such as shame, embarrassment, etc. and their rating, hunger evaluation module 14, is not able to evaluate immediately if the dieter's hunger is being caused by emotional rather than physical stimuli, and therefore requires more information which will be provided by answers to questions 108 through 118.

In another embodiment of the present invention, a shortcut prompt may be issued to the dieter at this step, allowing the system to skip ahead to step 126 and assume the hunger is emotionally driven. If the user selects the shortcut evaluation module, and hunger evaluation module 14 determines an emotionally driven hunger, system 10 may skip ahead to step 128. However, assuming that hunger evaluation module 14 still requires more information or the dieter does not select the shortcut option, the process proceeds normally. The questions and user's answers in response to the above questions may be used by system 10 for evaluation of the user's hunger, but they are equally valuable to the user to help them understand the emotions that are causing them to eat.

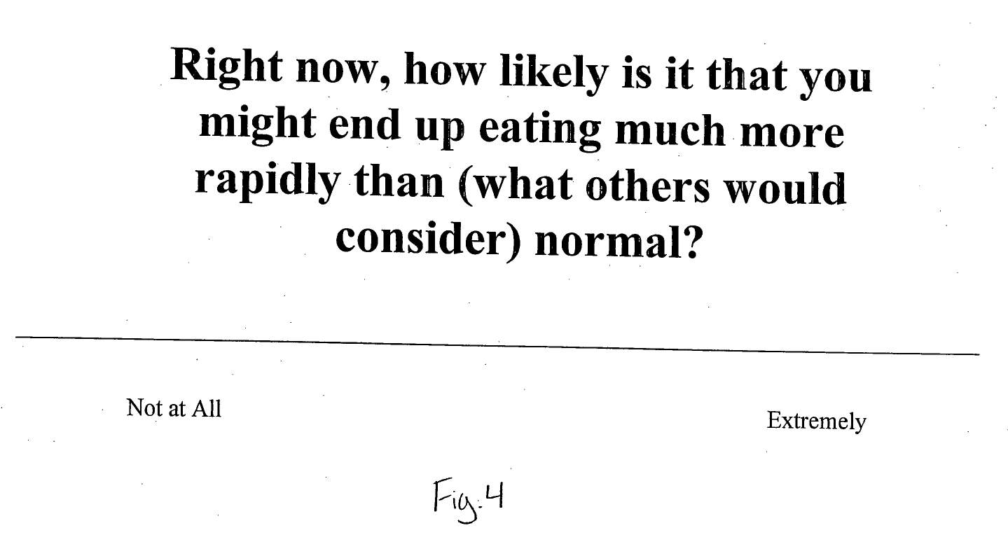

Next in step 108, the user is presented with a question regarding how likely is it that they might eat too rapidly. A sample interactive screen shown to the user at step 108, is shown in FIG. 4.

At step 110, the user is presented with a question regarding how likely is it that they might eat until they are uncomfortably full.

Again, at step 112, the user is presented with a question regarding how likely is it that they might eat large amounts of food without being physically hungry.

Next, at step 114, the user is presented with a question regarding how likely is it that they might end up eating alone in order to avoid embarrassment based on the large amounts they are eating.

At step 116, the user is presented with a question regarding how likely is it that they might feel disgusted with themselves or depressed after over eating.

Next, at step 118, the user is presented with a question regarding how likely is it that they might experience a loss of control over the amount they are eating.

The questions asked at steps 108 through 118 are based on the currently accepted clinical diagnostic criteria for binge (compulsive) eating disorder, and are aimed at detecting and quantifying in real time a user's emotional hunger, that is, a user's compulsive eating episode just about to happen, before it actually happens.

This is extremely critical if therapeutic interventions are to be successful, since little can be done to prevent binge episodes from occurring once they have already occurred, but a lot can be done if binge episodes are detected before or as they occur.

It is understood that the full range of questions presented at this stage is subject to change as the fields of binge/compulsive eating behaviors, and compulsive behaviors in general, evolve.

Any similar step of indicating an emotional state in connection with a similar compulsive eating behavior normalization and weight loss system and method is within the contemplation of the present invention.

After this series of questions regarding the emotional state of the user, at step 120, the user is presented with a question asking how much a gnawing or growling stomach distress, indicating physical hunger, they are currently experiencing. At step 122, the user is then asked either the time of their last meal (if the program has a timer with which to compare) or they are simply asked how long it has been since their last meal, using a sliding scale.

At step 124, a follow up question is issued asking the user how full they felt after their last meal; extremely full, comfortably full or not full at all.

Based on the answers to these questions, at step 126, hunger evaluation module 14 makes a determination on whether the hunger being experienced by the user is emotionally driven, physically driven, or a combination of both. The decision is based on a combination of factors including but not limited to the emotions being experienced, selected at steps 104 and 106, the emotional hunger and compulsive eating behavior questions asked in steps 108-118 and finally the physical hunger questions from steps 120-124.

When hunger evaluation module 14 is determining the cause of a user's hunger, it first collects all of the data on the emotions being felt at the time as indicated in step 104 and the strength of emotion as indicated in step 106. Hunger evaluation module then proceeds to check the emotional hunger and compulsive eating behavior questions from steps 108-118 and generates a decision on whether or not the hunger is emotionally driven.

One example of an evaluation algorithm used by hunger evaluation module 14 is to simply check the user's answers from the previously conducted emotional evaluation and conclude that the user's hunger is emotionally driven if any one of the answers to the questions reaches a predefined threshold. In this respect, if the user were to answer that it was likely that they will eat alone to avoid embarrassment (step 114) or be disgusted with themselves after eating (step 116).

Another example of an algorithm used by hunger evaluation module 14 may be a threshold algorithm where when a certain point total is reached among the answers to a combination of the above evaluation questions, hunger evaluation module determines that the user's hunger is at least part caused by emotional stimuli in the user.

In such an arrangement each of the various emotions that could be experienced by the user, including the list from step 104 as well as the specific questions in step 108-118, can each be given a weighting factor which is in turn multiplied by the range answer provided by the user (e.g. “not at all”=0.1, “moderate”=0.5, “extremely strongly”=1.0). Hunger evaluation module using the equation:
TCV=Σ(WF×RM)
where TCV=Threshold Comparison Value, WF=weighting factor for the emotion indicated by the user and RM=range modifier for that emotion indicated by the user. As such, the sum of the products of each of the weighting factors (WF) and range modifiers (RM) will provide the module with a threshold comparison value.

Different weighting factors (WF) can be used for each of the different evaluation questions based on their significance for indicating the likelihood of an emotionally driven hunger. For example, a higher weighting factor may be given to the question in step 116, where a user indicates that they are likely to be disgusted after they eat, than the answer to the question in step 108 where a user is indicating if they are likely to eat too fast. This difference in weighting factor ca be attributed to the fact that the question in step 116 is more indicative of an emotionally driven hunger than the question in step 108. Different weighting factors may be used for each of the different questions, and may even be modified for each individual user, based on the personal eating and emotional habits.

Next, the threshold comparison value is compared against the threshold value. If the threshold comparison value is less than the threshold value, hunger evaluation module 14 will determine that the hunger is not emotionally driven. On the other hand, if the threshold comparison value is greater than the threshold value, hunger evaluation module 14 will determine that the hunger is emotionally driven.
TCP<TV=Not emotionally driven
TCP>TV=Is emotionally driven

The numbers used for calculation, such as the threshold values, weighting factors assigned to each emotion and range modifiers as designated by the user, may be arbitrarily selected based on the requirements of compulsive eating behavior normalization and weight loss system 10, so long as the numbers are consistently applied.

It is understood that the above is only one example of a calculation scheme used by hunger evaluation module 14, however, any similar method used to determine if a user's hunger is emotionally driven in a similar compulsive eating behavior normalization and weight loss system 10, is within the contemplation of the present invention.

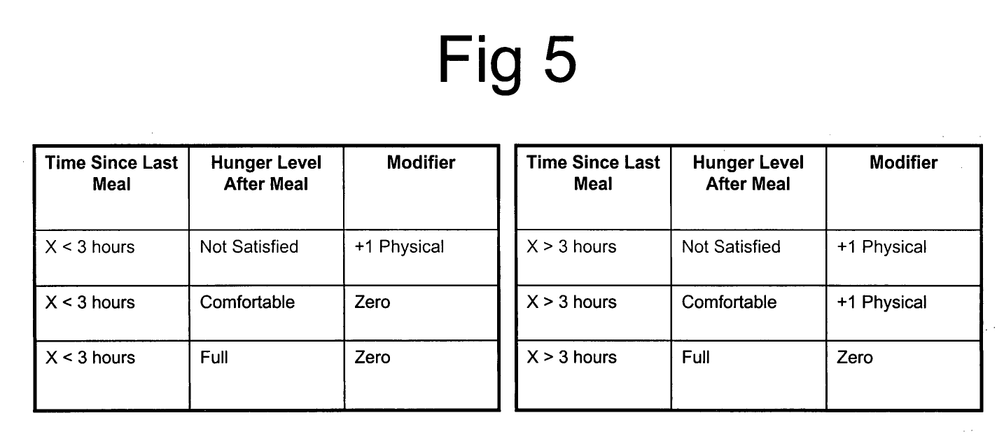

In addition to the weighting of the questions conducted by hunger evaluation module 14, system 10 also may employ series of default factors that assist in determining if the hunger is simply a physical hunger. For example, as illustrated in the chart in FIG. 5, if in step 122, the user answered that it has been more than three hours since their last meal, and in step 124, they stated that they were “not full at all” at the end of their last meal, then hunger evaluation module 14, may add an extra weighting component in favor of finding that hunger experienced is at least in part physically based. Likewise, if in step 122, the user answered that it has been less than three hours since their last meal, and in step 124, they stated that they were either “comfortably full” or “more than comfortably full” at the end of their last meal, then hunger evaluation module 14 may add an extra weighting component in favor of finding that hunger being experienced is unlikely to be physically (physiologically) based.

It is understood that the number of possibilities for determining whether the user's hunger is emotionally or physically driven is too extensive to describe in detail. Any such eating normalization and dieting or weight loss system that employs a similar series of exchanges and evaluations is within the contemplation of the present invention.

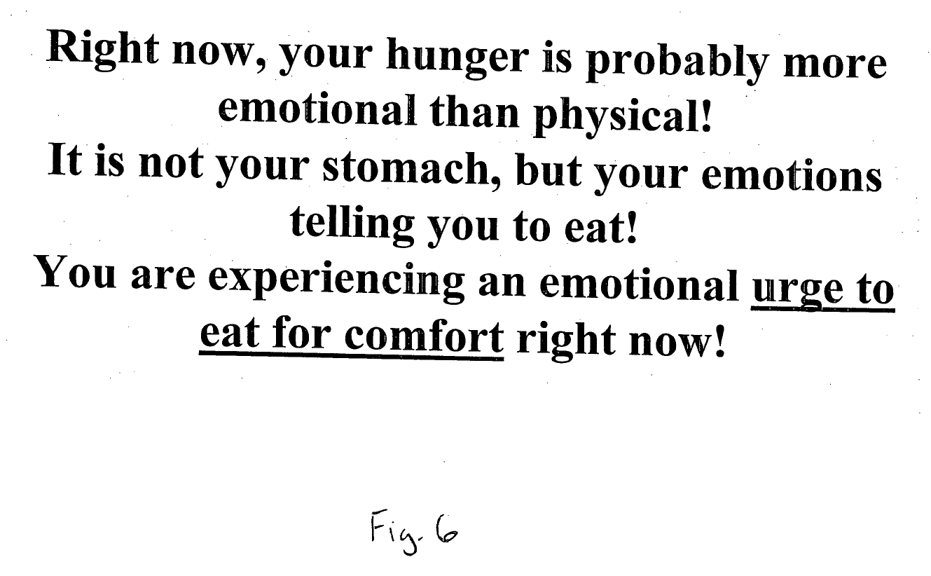

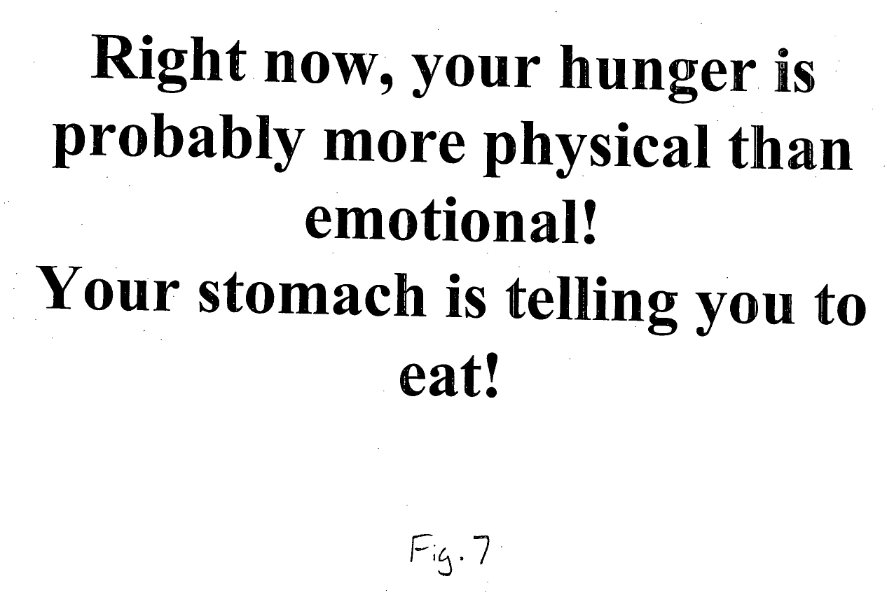

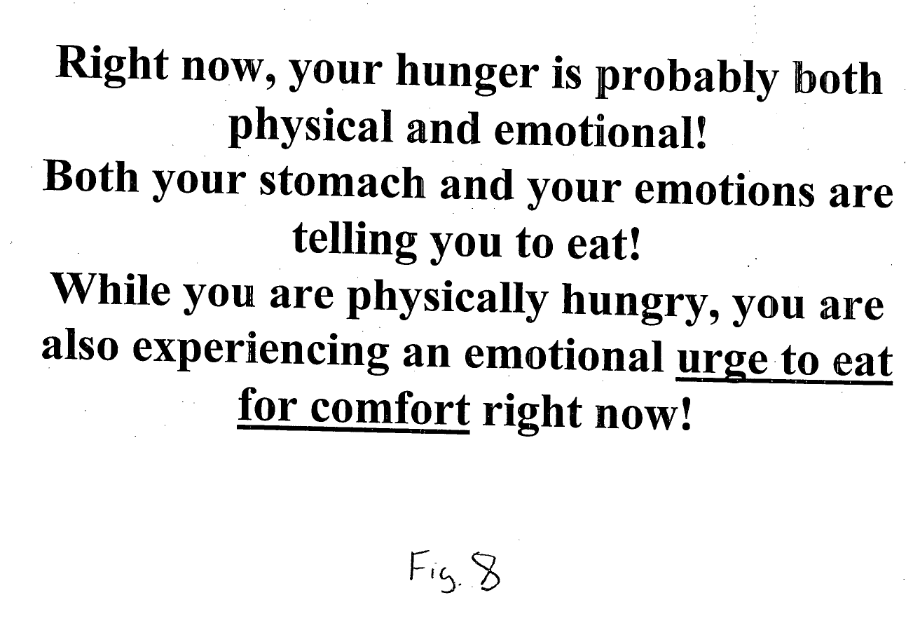

After hunger evaluation module makes its decision at step 126, the user is prompted at step 128 with the decision results. There are three possible results to be shown to the user. The first interactive screen, as illustrated in FIG. 6, states that the hunger is probably more emotional than physical in nature, the second interactive screen, as illustrated in FIG. 7, states that the hunger is probably more physical than emotional in nature, and the third interactive screen, as illustrated in FIG. 8, states that the hunger is probably both emotional and physical in nature. Based on the outcome, system 10 proceeds to take the user to the appropriate follow up routine as described in more detail below.

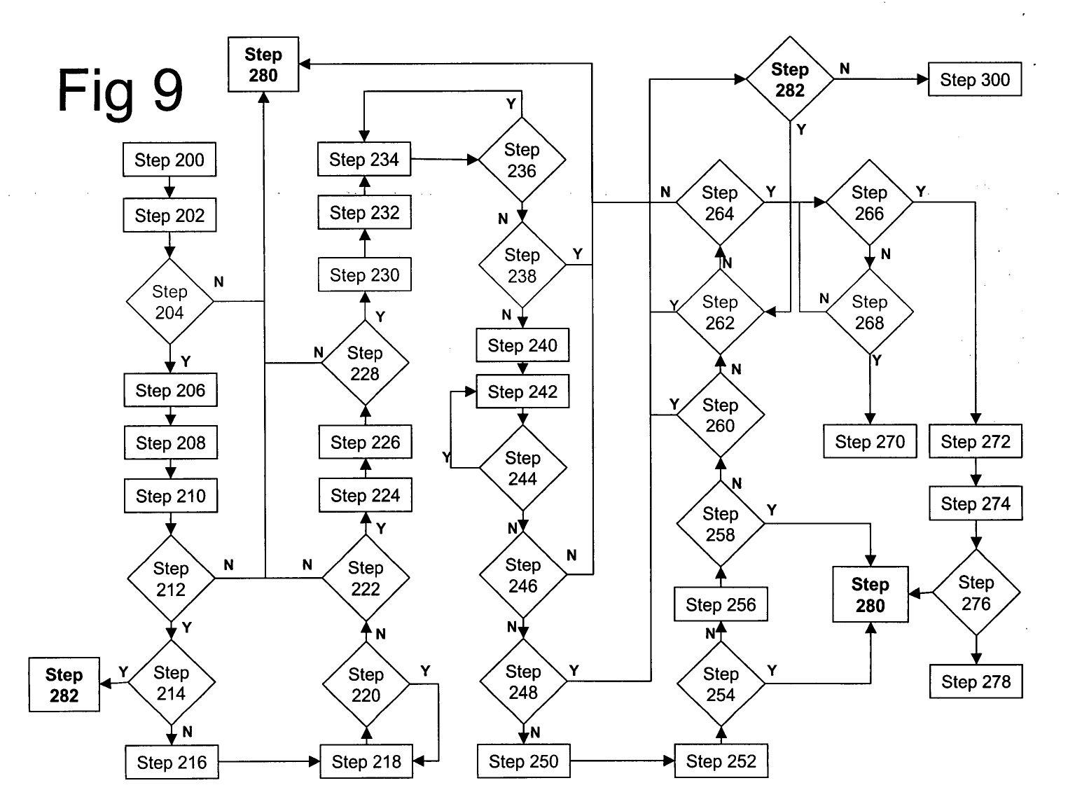

In one embodiment of the present invention, as illustrated in the flow chart of FIG. 9, once it has been determined that the hunger experienced by the user is caused at least in part by emotional stimuli, emotional hunger management module 16, begins communication with the user via interface module 12, using interactive screens similar to those used by hunger evaluation module 14.

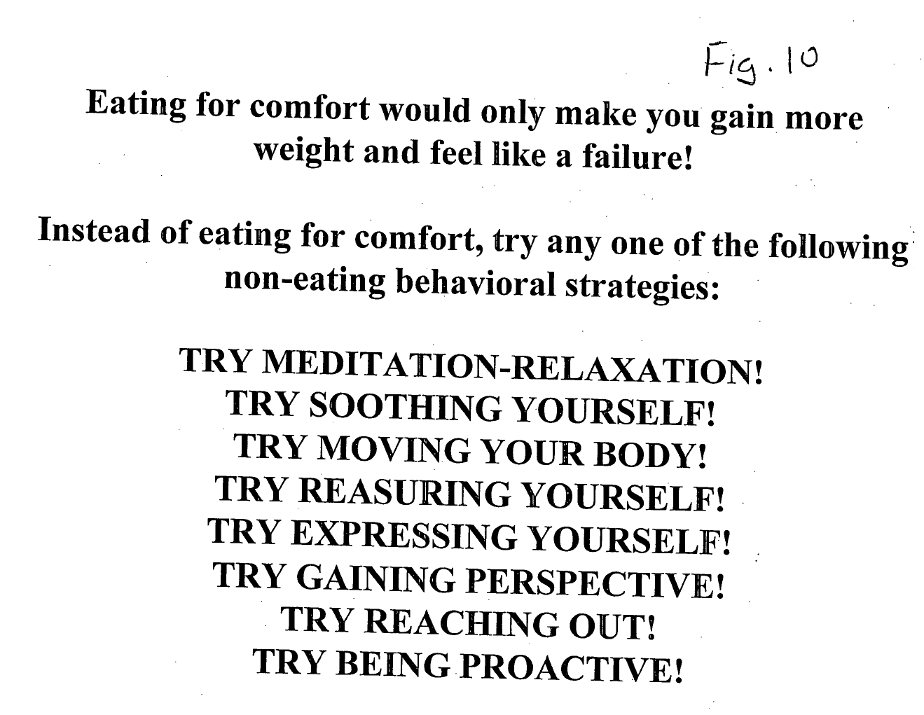

At a first step 200, emotional hunger management module 16, provides a first motivational statement, and then encourages the user to take an affirmative step to stem the emotional hunger. This step may include, but is not limited to meditation, moving around, self-reassuring or expressing oneself. A sample interactive screen displayed to the user at step 200 is shown in FIG. 10.

Next at step 202, emotional hunger management module 16, provides the user with a guide to a breathing meditation-relaxation. This guide can include a number of meditative steps. For example, at step 202, the user can be presented with a multi step breathing process and instructions on imaging the hunger disappearing. It is understood that this method of meditation-relaxation is only listed as an example for illustrative purposes and that any such meditative process used in a similar system and method for avoiding compulsive eating or any other compulsive behavior is within the contemplation of the present invention.

At step 204, the user is asked if they are still feeling the urge to eat. If the user answers no, they are finished with the emotional hunger management module and may skip forward to step 280. If the user is still feeling an urge to eat for comfort, the system proceeds to the next step 206, where the user is again confronted with a supportive statement and is urged to overcome the hunger, in a similar fashion to step 200.

Next, at step 208, the user is prompted to sooth themselves through a process of addressing their five senses, of touch, taste, sight, sound or smell so as to change their focus. The user is prompted to try each sense, such as listening to soothing music, smelling a candle or flower, tasting a cough drop or chewing gum, visualizing or looking at a serene picture, or touching a pressure point on their body at the ears or even applying hand lotion or cold water on their skin. At step 210, the user is prompted to do it again, repeatedly until they desire to move on.

At step 212, the user is again prompted with an interactive screen asking if they still feel the urge to eat for comfort. If the emotionally driven hunger has been assuaged then the user may skip ahead to step 280. However, assuming they still desire to eat, the program continues to the next step.

At step 214, the user is confronted with an interactive screen which simply asks if the user wishes to continue to attempt to manage the emotional hunger or if they wish to give up and decide to eat. If the user decides to forgo any further attempts to relieve the emotional stimuli, the program advances to step 282 managed by physical hunger management module 18. Alternatively, if the user decides to continue to attempt to manage the emotional hunger, the program proceeds to step 216, where the user is again presented with a congratulatory interactive screen, encouraging the user to continue to with their efforts to assuage their emotional desire to eat.

Next, at step 218, the user is asked to move around, exercise, or conduct some other brief physical exertion for a timed period (at least 60 seconds). At step 220, they are asked if they wish to continue the physical exertion or possibly conduct a different type of physical exertion. This process is continued until the user decides to stop the physical exertion. At step 222 the user is asked again if they are still experiencing an emotional desire to eat. If the answer is no, the user proceeds ahead to step 280. However, if the answer is yes, the process continues along to step 224, where the user is again presented with an interactive screen that is intended to reassure the user and present yet another option for relieving the emotional need to eat.

At step 226, the user is prompted to take a deep breath and come up with one or more self reassuring observations. Next, at step 228, the user is again asked if they are still feeling an emotional drive to eat. If they answer no, then the user is advanced ahead to step 280.

However, if the user is still experiencing emotionally driven hunger then they advance forward to step 230, where they are confronted with another interactive screen which congratulates them on their success thus far and gives them the option to go on to eat or to continue to attempt to remove the emotionally driven hunger. If the user chooses to eat they are forwarded ahead to step 282. Alternatively, if the user chooses to continue to work on combating their emotional needs for eating, they continue on to step 232 where they are again congratulated and presented with yet another series of options.

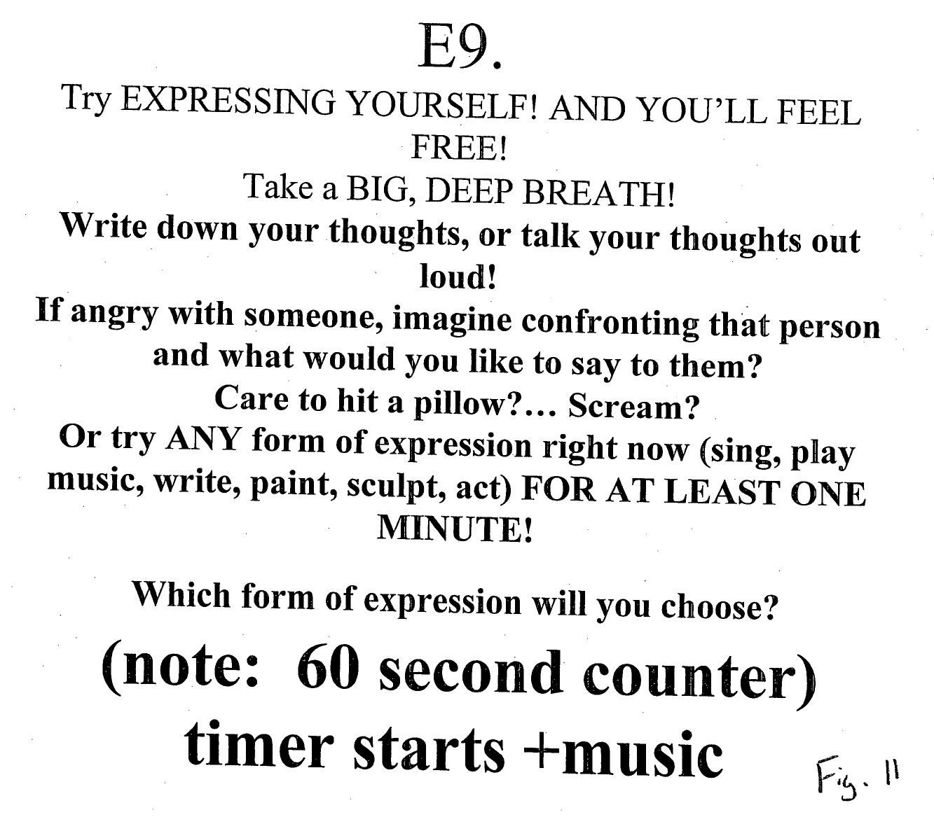

Next, at step 234, the user is prompted with an interactive screen that encourages them to express themselves in some way such as talking, writing or painting, again so as to change the focus of their thoughts and feelings. A sample of this interactive screen from step 234 is seen in FIG. 11. At step 236, the user is prompted to repeat the step as often as necessary. At step 238, after the user is finished, they are asked again if they are still feeling the desire to eat for emotional reasons. If they answer no, the user is forwarded to step 280. If they answer yes at step 238, at step 240, the system proceeds to a next congratulatory interactive screen, presenting a series of new exercises that are to be carried out by the user in the ensuing steps.

At step 242, the user is prompted to do a visualization exercise, in attempt to gain perspective, confidence and security. At step 244, the user is prompted to repeat the visualization exercise. When the user is finished, at step 246 the user is asked if they are still feeling an emotional drive to eat. If they answer no, then the user is advanced ahead to step 280.

If the user is still experiencing emotionally driven hunger then they advance forward to step 248, where they are confronted with another interactive screen that congratulates them on their success thus far and gives them the option to go on to eat or to continue to attempt to remove the emotionally driven hunger. If the user chooses to eat they are forwarded ahead to step 282. Alternatively, if the user chooses to continue with the emotional exercises they continue on to step 250 where they are again congratulated and presented with yet another series of options.

Next, at step 252, the user is prompted to reach out to someone. For example, the user may call a friend or family member or even walk around the office to talk to a friend.

At step 254, the user is asked if they are still feeling an emotional need to eat. If not, the user is advanced to step 280. However, if the user answers yes, then, at step 256, the user is instructed to set a goal for themselves and start working towards it in an attempt to be proactive. For example, if the user wishes to write a book, then at step 256, the user should set a goal of writing at least one page of the book and work to finish that minimal goal. This intended as an example, however it is understood that any incremental or short term goal set and performed in this context is within the contemplation of the present invention.

Steps 202 through 258 represent in essence a sequence of non-eating behavior alternatives suggested by system 10 to replace any compulsive eating behavior which may be prompted by emotional hunger in the user. The sequence of these steps is to be chosen by the user at each step along the way as they go through the program.

It is understood that the sequence of these non-eating behavior alternatives listed here by is only an example for illustrative purposes and that any such non-eating alternative behaviors and their combinations used in a similar system and method for avoiding compulsive eating or any other compulsive behaviors is within the scope and the contemplation of the present invention.

After reaching the minimal goal, at step 258, the user is asked again if they are still feeling the desire to eat for emotional reasons. If they answer no, the user is forwarded to step 280. If they answer yes, at step 260, they are moved to a next interactive screen where the user is presented with the option to either eat or continue with the emotional support program. If they choose to eat they are forwarded to step 282. However, if they choose to continue with the emotional support program, the user progresses to step 262, where the user is allowed to take a small, single bite from their rescue food.

Rescue food refers to any food chosen by the user which meets the following five criteria: 1. is enjoyable to the user, 2. is conveniently available to the user, 3. is low in calories, 4. is rich in fiber, 5. is rich in water, (water can however be added separately if a chosen rescue food is dry), where a single bite will not greatly affect the overall diet scheme. A typical example of rescue food may be a vegetable or a fruit, juice, air popped popcorn or even a dietary health bar.

Next, at step 264, the user is asked if the rescue food has caused the emotionally driven hunger to subside. If it has, and they are no longer experiencing an emotional hunger to eat, the user is forwarded ahead to step 280. However, if the rescue food has still left them with an emotional need to eat, at step 266, the user is again allowed to take a few more bites of the same rescue food.

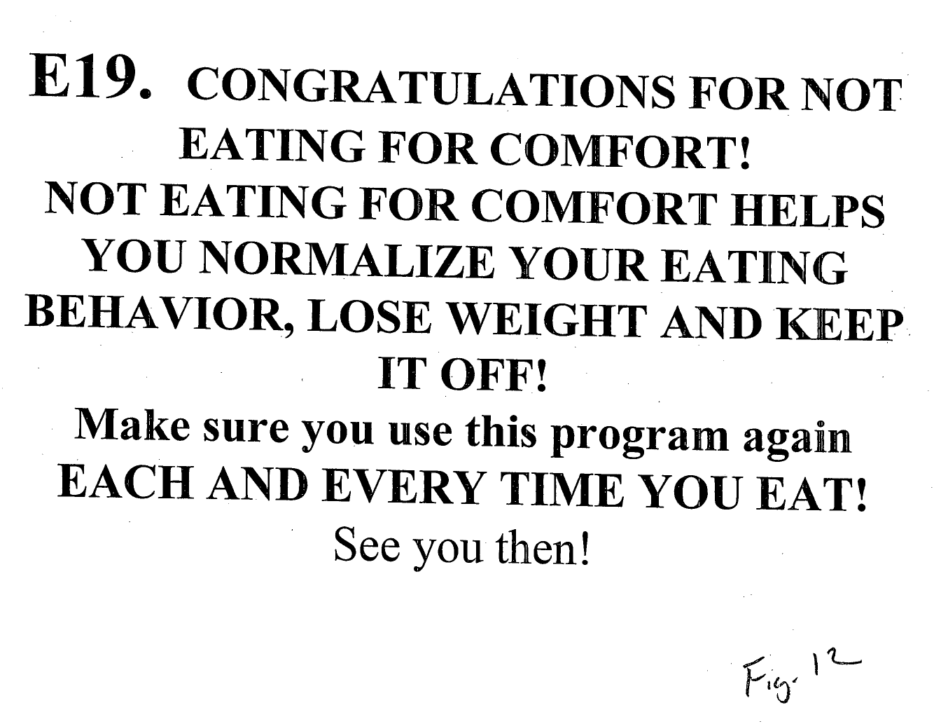

At step 268, the user is asked how full their stomach feels after having eaten their rescue food. If the user answers that they are more than comfortably full, the user completes the emotional hunger module 16, at step 270, illustrate in FIG. 12, where the user is congratulated for not eating based on their emotions (except for their rescue food), but are warned that they had to eat too much of their rescue food to achieve this.

If at step 268, the user answers they are less than comfortably full then they are returned to step 266 where they are allowed to eat a few more bites of their rescue food if they still experience the emotional hunger. However, if the user answers that they are comfortably full, then they continue on to step 272 where they are asked if they still have an emotional desire to eat. If not, the user is forwarded on to step 280. However, if they are still experiencing an emotional desire to eat even after the rescue food, then the user advances to step 274 where they are prompted to take a short (one minute) break, while possibly drinking some water. After the (one minute) break the user is asked again at step 276 if they are still experiencing an emotionally driven hunger. If yes then they proceed to step 278 where they are prompted to call a hunger/eating hotline for additional emotional assistance. However, if the emotional hunger has been overcome, then they proceed to step 280, as illustrated in the interactive screen in FIG. 12, where emotional hunger management module 16 issues a final congratulation for overcoming the emotionally driven hunger and concludes the session.

It is noted that step 280 the final interactive screen reached at this congratulatory step is the same interactive screen that is presented at any time during the emotional management session when the user answers that they are no longer feeling an emotionally driven hunger.

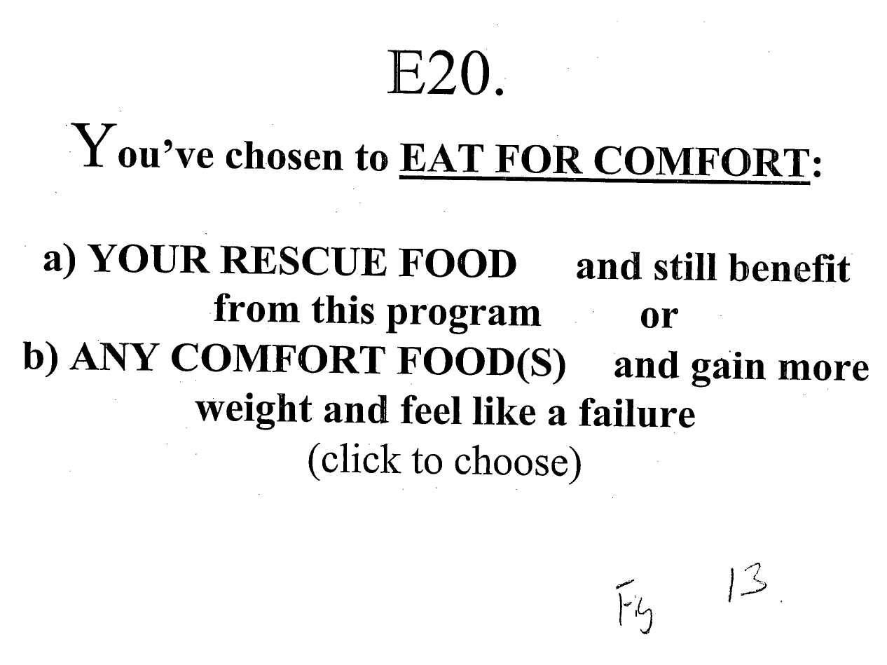

Likewise, the remaining step 282, illustrated in the interactive screen in FIG. 13, is reached at anytime during the program when the user as indicated that they intend to eat even though they had not overcome the emotional desire to eat. Regardless of when a user fails to overcome their emotional desire to eat and reaches this step 282, the user may choose to make a last attempt to resist eating a full meal by eating more rescue food at which point they are forwarded to step 262 to continue the process from there, or they can choose to eat any type of food at which point they are transferred to the physical hunger management module for further assistance.

As such, emotional hunger management module 16 takes the user through a step by step process in an attempt to relive the user of their emotionally driven hunger. This results in either: 1) successfully reaching step 280; 2) reaching the slightly less successful step 270; or 3) reaching the unsuccessful steps 278 or 282, assuming at step 282 the user chooses to eat more than just rescue food.

At this point, after completing emotional hunger management module 16, the user may progress onto to physical hunger management module 18 depending on certain factors. The user will progress to physical hunger management module if they decided to eat after reaching either step 282 or step 278 in emotional hunger management module 16 and made the decision to eat more than just their rescue food. Alternatively, a user may end up in physical hunger management module 18 if hunger evaluation module 14 decided at step 128 that the hunger being experienced by the user was entirely physical in nature.

It is understood that other methods for reaching the steps in the physical hunger management module 18 such as direct access for whatever reason is also within the contemplation of the present invention.

In either event, the user is taken through a series of steps by physical hunger management module 18 in order to encourage the user to make better decisions in their choice of foods to eat. To this end, the user is first asked to identify based on their five senses which food attributes are important to them when they make food selections.

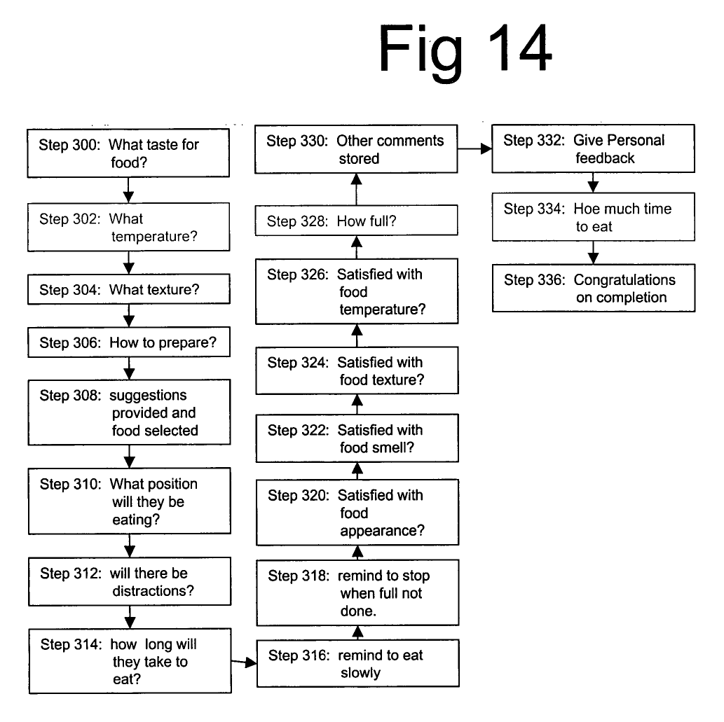

In one embodiment of the present invention, as illustrated in the flow chart FIG. 14, physical hunger management module 18 begins at step 300, presenting an interactive screen to the user asking them what taste they would like their food to have. The user may then select from choices such as salty, sour, sweet, nutty and so on. Next, at step 302, the user is asked what texture they would like their food to have such as solid, liquid, or chewy. At step 304, the user is asked what temperature they would like their food to be.

Next, at step 306, the user is asked how they would like the food prepared. In this section the preparations are divided into most healthy (raw, baked, poached), less health (sauteed, stir-fried) and least healthy (fried, deep fried, pan-fired) types of food preparation. At step 308, the user is told what they should select based on their preferences and then are prompted to enter their food selection. It is assumed that the user will be preparing his food according to these indications, however it is contemplated that such a system can also be used to provide instructions to a third party to provide food to the user prepared according to these specifications.

As discussed above, physical hunger management module 18, may provide the food and preparation suggestions to the use based on any specific diet requirements (low-carbohydrate, low sodium etc.) or it may provide the food suggestions directly from seamlessly integrated preexisting commercial diet plans.

At step 310, the user is asked how they will be physically positioned for eating: sitting, standing or lying down. At step 312, the user is asked whether they will be focused on eating without distractions or if they will be eating while doing something else, a less healthy alternative.

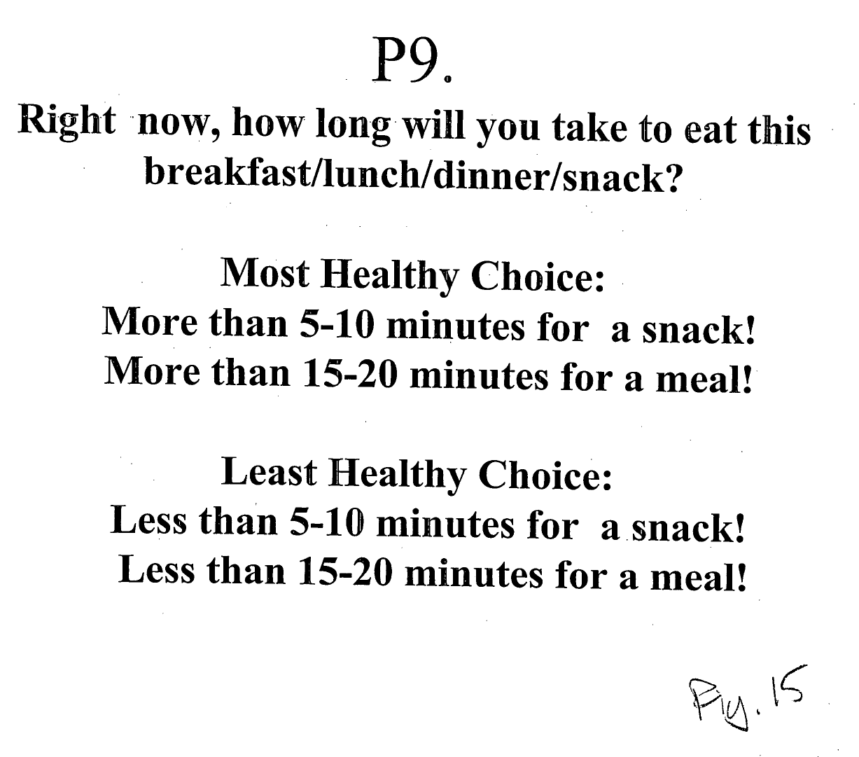

Next, at step 314, the user is asked how long they will take to eat the meal. A sample of the interactive screen present in step 314 is seen in FIG. 15. The user is instructed that it is more healthy to take at least 5-10 minutes to eat a snack and at least 15-20 minutes to eat breakfast lunch or dinner.

At step 316, the user is prompted with an interactive screen reminding them to eat slowly and finish each bite before taking the next. Next, at step 318, the user is reminded to stop eating as soon as their stomach feels full, as opposed to continuing to eat until all of the food is gone.

After eating the meal, at step 320, physical hunger management module 18, progresses the user along to a next interactive screen asking the user if the food's appearance has satisfied the user. At step 322, the user is asked if the food smelled and tasted good. Next, at step 324, the user is asked if the texture of the food was satisfying. At step 326, the user is asked if the temperature of the food was satisfying.

After answering that series of questions, the user is then prompted at step 328 to answer how full they are: not at all, comfortable or extremely full. Next, at step 330, physical hunger management module 18 informs the user what they have and have not been satisfied with and asks what the user could do differently next time for their eating experience to be more satisfying. These results may be recorded to make suggestions in future sessions with physical hunger management module 18.

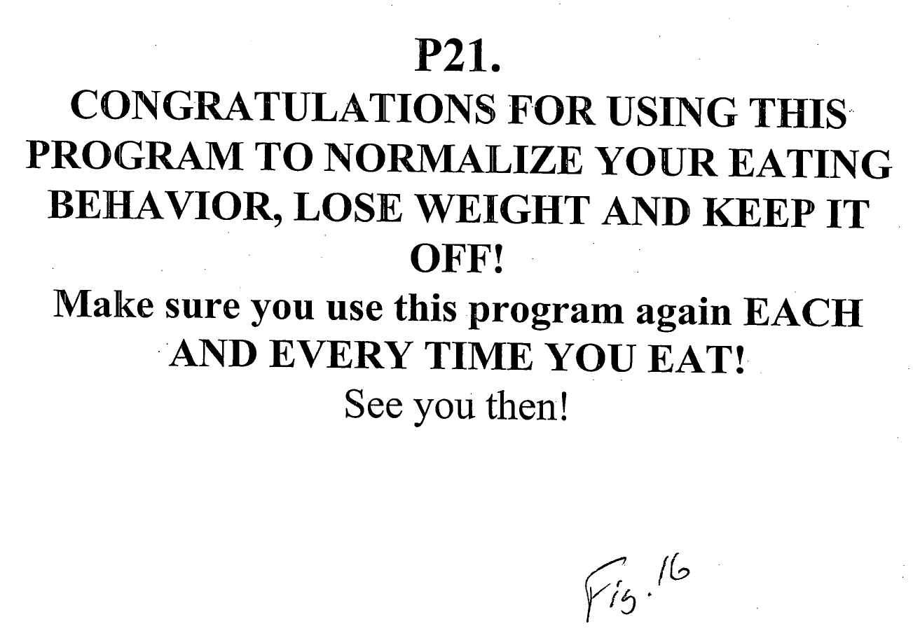

At step 332, the user is also reminded of whether or not they have overeaten and prompted to give personal feedback that may assist in formulating future sessions. At step 334, the user is prompted to enter the amount of time that it took to eat their meal or snack, and is reminded of the optimum times for completing meals or snacks. Finally, at step 336, an interactive screen is shown to the user, as illustrated in FIG. 16, congratulating the user on completing the session with physical hunger management module 18.

In view of the foregoing, a compulsive eating behavior normalization and weight loss system and method has been described in which a user is able to interact with compulsive eating behavior normalization and weight loss system 10, in order to reach the normalizing eating behavior and weight loss goal. The description of compulsive eating behavior normalization and weight loss system 10 and the accompanying method of interaction with the user is intended only as an example of a system and method for compulsive eating behavior normalization and weight loss, illustrative of the present invention, and in no way intended to limit its scope. It is understood that a similar weight loss arrangement that employs the salient features of system and method is within the contemplation of the present invention.

While only certain features of the invention have been illustrated and described herein, many modifications, substitutions, changes or equivalents will now occur to those skilled in the art. It is therefore, to be understood that this application is intended to cover all such modifications and changes that fall within the true spirit of the invention.

What is claimed is:

1. A system for assisting a user in compulsive eating behavior normalization and weight-loss, said system comprising:
an interface module configured to allow said user interface with said system;
a hunger evaluation module, coupled to said interface module, configured to evaluate said user's desire to eat to determine if it is caused by emotional stimuli, physical stimuli or both;
an emotional hunger management module, coupled to said interface module configured to interact with said user to assist in alleviating emotional stimuli to eat; and
a physical hunger management module, coupled to said interface module, configured to assist said user when the decision to eat has been made.

2. The system as claimed in claim 1, further comprising a storage module.

3. The system as claimed in claim 2, wherein said storage module is configured to store information entered by said user into said weight loss system, so as to be used by said hunger evaluation module, said physical hunger management module, and said emotional hunger management module.

4. The system as claimed in claim 3, wherein said storage module stores the results of a user's progress with said weight loss system, wherein said progress may be reviewed and analyzed at a later time.

5. The system as claimed in claim 1, wherein said interface module is configured to present a series of questions to said user in the form of interactive screens, presented using a computer slide program.

6. The system as claimed in claim 5, wherein said hunger evaluation module evaluates said user's desire to eat, based on either emotional stimuli, physical stimuli or both, based on said answers received at said interface module.

7. The system as claimed in claim 1, wherein said hunger evaluation module is further configured to measure a user's responses against a threshold value, such that when said user's responses exceed said threshold value, said hunger evaluation module determines that a user's hunger is emotionally driven.

8. The system as claimed in claim 1, wherein said hunger evaluation module is further configured to include a biasing element regarding a physical desire to eat based on said user's answers to questions related to how long it has been since their last meal.

9. The system as claimed in claim 1, wherein said emotional hunger management module assists in alleviating said user's emotional stimuli to eat, by presenting a plurality of emotionally calming exercises to be performed by said user.

10. The system as claimed in claim 9, wherein said plurality of emotionally calming exercises are presented in the form of interactive screens, using a computer slide program.

11. The system as claimed in claim 9, wherein said plurality of emotionally calming exercises are interactive, requiring a response from said user.

12. The system as claimed in claim 1, wherein said physical hunger management module, assists said user when the decision to eat has been made, using a series of interactive screens, presented using a computer slide program.

13. The system as claimed in claim 12, wherein said plurality of interactive screens presented by said physical hunger management module are interactive, requiring a response from said user.

14. The system as claimed in claim 1, wherein said physical hunger management module is further configured to provide assistance to said user in their eating decisions in accordance with specific dietary requirements.

15. The system as claimed in claim 1, wherein said physical hunger management module is further configured to provide assistance to said user in their eating decisions in accordance with preexisting commercial diet plans.

16. The system as claimed in claim 1, wherein said weight loss system is presented to said user on any one of, a personal computer, a PDA, an SMS device, a mobile phone, a text pager, an audio CD, a DVD, and an on-line session.

17. A method for assisting a user in compulsive eating behavior normalization and weight-loss, said method comprising the steps of:
evaluating said user's hunger to determine if the desire to eat is based on emotional stimuli, physical stimuli or both;
interacting with said user to assist in alleviating emotional stimuli to eat; and
assisting said user when the decision to eat has been made.

18. The method as claimed in claim 17, wherein said step of evaluating said user's hunger is performed by presenting said user with a series of question and answer interactive screens, using a computer slide program.

19. The method as claimed in claim 17, wherein said step of evaluating said user's hunger further comprises the step of asking how long it has been since the user's last meal.

20. The method as claimed in claim 19, further comprising the step of adding a biasing element regarding a physical desire to eat based on said user's answers to questions related to how long it has been since their last meal.

21. The method as claimed in claim 17, wherein said step of interacting with said user to assist in alleviating emotional stimuli to eat is performed by presenting a plurality of emotionally calming exercises to be performed by said user.

22. The method system as claimed in claim 21, wherein said plurality of emotionally calming exercises are presented as interactive screens, using a computer slide program.

23. The method as claimed in claim 21, wherein said plurality of emotionally calming exercises interactively require a response from said user.

24. The method as claimed in claim 17, wherein said step of assisting said user when the decision to eat has been made uses a series of interactive screens, presented using a computer slide program.

25. The system as claimed in claim 24, wherein said plurality of interactive screens presented by said physical hunger management module interactively require a response from said user.

26. A method for evaluating a user's desire to eat, said method comprising the steps of:
A) presenting the user with a first set of questions requesting the user to indicate which emotional feelings they are experiencing.
B) presenting the user with a second set of questions requesting the user to indicate the degree to which they are experiencing said feelings.
C) presenting the user with a third set of questions, a range of emotionally indicative questions; and
based on said answers to said third set of questions evaluating whether or not said user's desire to eat is based on emotional stimuli.

27. The method as claimed in claim 26, wherein said third set of questions includes a question asking the user if they might eat too rapidly.

28. The method as claimed in claim 26, wherein said third set of questions includes a question asking the user if they might eat until they are uncomfortably full.

29. The method as claimed in claim 26, wherein said third set of questions includes a question asking the user if they might eat large amounts of food without being physically hungry.

30. The method as claimed in claim 26, wherein said third set of questions includes a question asking the user if they might end up eating alone in order to avoid embarrassment.

31. The method as claimed in claim 26, wherein said third set of questions includes a question asking the user if they might feel negatively after over eating.

32. The method as claimed in claim 26, wherein said third set of questions includes a question asking the user if they might experience a loss of control over the amount they are eating.

33. The method as claimed in claim 26, wherein said user is presented with a first set of questions, requesting the user to indicate which emotional feelings they are experiencing.

34. The method as claimed in claim 33, wherein said user is presented with a second set of corresponding questions, requesting the user to indicate the degree to which they are experiencing said feelings.

35. The method as claimed in claim 26, wherein in said third set of questions each question and corresponding answer is given a particular weighting factor.

36. The method as claimed in claim 35, wherein in said third set of questions, said user answer provides a range modifier.

37. The method as claimed in claim 36, further comprising the step of multiplying said range modifier with said weighting factor to form a threshold comparison value, such that if said threshold comparison value is over a predetermined threshold value, a determination is made that the user's desire to eat is based on emotional stimuli.

38. The method as claimed in claim 26, further comprising the step of presenting a fourth set of questions to said user, regarding physical reasons for eating; and
presenting a fifth set of questions to said user, corresponding to said fourth set of questions, requesting the user to indicate the degree to which they are experiencing said physical conditions.

39. The method as claimed in claim 38, further comprising the step of determining if the user's hunger is based on physical stimuli, based on the answers to the fourth and fifth set of questions.

40. The method as claimed in claim 39, further comprising the step of asking how long it has been since the user's last meal.

41. The method as claimed in claim 40, further comprising the step of asking how full the user was at the end of their last meal.

42. The method as claimed in claim 41, further comprising the step of adding a biasing element regarding a physical desire to eat based on said user's answers to questions related to both how long it has been since their last meal and how full they were at the end of their last meal.
